(19) United States
(12) Patent Application Publication
(10) Pub. No.: US 2016/0005038 A1
(43) Pub. Date: Jan. 7, 2016

(54) ENHANCED USER AUTHENTICATION PLATFORM

(71) Applicant: MasterCard International Incorporated, Purchase, NY (US)

(72) Inventors: Ashfaq Kamal, White Plains, NY (US); Gregory D. Williamson, Stamford, CT (US)

(21) Appl. No.: 14/789,361

(22) Filed: Jul. 1, 2015

Related U.S. Application Data
(60) Provisional application No. 62/020,555, filed on Jul. 3, 2014.

(51) Int. Cl. G06Q 20/40; G06Q 20/32

(52) U.S. Cl. CPC G06Q 20/405; G06Q 20/3226

(57) ABSTRACT

Systems and methods for multi-factor user authentication techniques usable in transactions. In some embodiments, an authentication platform receives a request to authenticate a user in conjunction with an online transaction and determines an authentication rule. The authentication platform then transmits an authentication request to the user's mobile device, receives authentication response data from the user mobile device, and authenticates the user in conjunction with the transaction when the authentication response data matches stored user authentication data. An authentication message is then transmitted to the user's mobile device. In some embodiments, the authentication response data is biometric data of the user obtained from at least one authenticator of the user's mobile device.

### CROSS-REFERENCE TO RELATED APPLICATIONS

The present application claims the benefit of U.S. Provisional Patent Application No. 62/020,555 entitled “Enhanced Authentication Platform” filed on Jul. 3, 2014, the entire contents of which are incorporated herein by reference.

### FIELD OF THE INVENTION

Embodiments described herein generally relate to authentication techniques. More particularly, embodiments relate to multi-factor user authentication techniques usable in transactions such as payment transactions.

### BACKGROUND

More and more transactions involve a user operating a mobile device. A common example of a transaction is a payment transaction, although a large number of other types of transactions benefit from the improved authentication techniques described herein. For convenience, payment transactions will be described, however, those skilled in the art, upon reading this disclosure, will appreciate that other types of transactions may be used with the authentication techniques described herein. In many types of transactions, it is increasingly important that the user involved in such transactions be authenticated. Often, the user is authenticated using a personal identification number (“PIN”) or the like. However, it is becoming increasingly important to provide additional authentication layers (referred to herein as “multi-factor” authentication) for improved security and authentication.

Card issuers and other financial institutions now offer or use standardized Internet transaction protocols to improve online transaction performance and to accelerate the growth of electronic commerce. Under some standardized protocols, card issuers or issuing banks may authenticate transactions thereby reducing the likelihood of fraud and associated chargebacks attributed to cardholder not-authorized transactions. One example of such a standardized protocol is the 3-D Secure Protocol. The presence of an authenticated transaction may result in an issuer assuming liability for fraud should it occur despite efforts to authenticate the cardholder during an online purchase. Merchants are assured by card issuers or issuing banks that they will be paid for issuer-authenticated transactions. The 3-D Secure protocol is consistent with and underlies the authentication programs offered by card issuers (e.g., Verified by Visa™ or MasterCard SecureCode™) to authenticate customers for merchants during remote transactions such as those associated with the Internet (commonly referred to as online transactions).

The 3-D Secure Protocol leverages existing Secure Sockets Layer (SSL) encryption functionality and provides enhanced security through issuer authentication of the cardholder during the online shopping session. It would be desirable to provide multi-factor authentication technologies in such transactions.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram of a transaction system according to an embodiment of the disclosure;

FIGS. 2A and 2B illustrate examples of user interface screens in accordance with mobile device user authentication processes according to some embodiments of the disclosure;

FIG. 3A depicts screenshots of a smartphone to illustrate further user interfaces pursuant to a user mobile application online purchase experience according to some embodiments of the disclosure;

FIG. 3B depicts screenshots of a smartphone to illustrate further user interfaces in accordance with a user mobile application control experience pursuant to some embodiments of the disclosure;

FIG. 4 is a block diagram of a portion of a transaction system to illustrate a Fast Identity Online Alliance (“FIDO”) implementation for performing an authentication transaction pursuant to some embodiments of the disclosure;

FIG. 5 is a block diagram of a portion of a transaction system accessible by multiple data points for performing user authentication processes for transactions pursuant to some embodiments; and

FIG. 6 is a block diagram of a portion of a transaction system for illustrating user registration and authentication transaction processing pursuant to some embodiments of the disclosure.

### DETAILED DESCRIPTION

In general, and for the purpose of introducing concepts of novel embodiments described herein, provided are systems, apparatus and methods for providing improved and/or enhanced user authentication for transactions including, for example, financial transactions.

In some embodiments, improved authentication techniques and methods are provided which allow an improved user experience for merchants and consumers, especially when used in conjunction with transactions involving mobile devices.

Further, in some embodiments, authentication techniques may include additional authentication levels that may be determined by a card issuer and/or on a transaction by transaction basis, allowing the authentication required for a given transaction to be enhanced in some situations. Embodiments provide improved adoption of such authentication techniques, as well as the reduction of declined transactions which are legitimate card not present transactions.

Pursuant to some embodiments, a user's connected mobile wireless device (such as a smart phone, tablet computer, digital music player, laptop computer, smart watch, personal digital assistant (PDA), or the like) can be used to provide additional factors for authentication in online transactions. Embodiments utilize secure push authentication technology on mobile devices to deliver to users an optimal user experience and to deliver layered authentication factors. For example, authentication technologies such as finger print biometrics, voice biometrics, and others may be utilized with the architecture disclosed herein. Embodiments utilize an authentication platform (which will be described further herein) to allow an identification of the appropriate authentication process(es) to be used in particular transactions for a given user. The authentication platform may be used in conjunction with a number of different types of transaction processes to provide the appropriate user authentication. Throughout this disclosure, an example of a financial transaction will be described. However, those skilled in the art will appreciate that embodiments may be used with desirable results in other types of transactions.

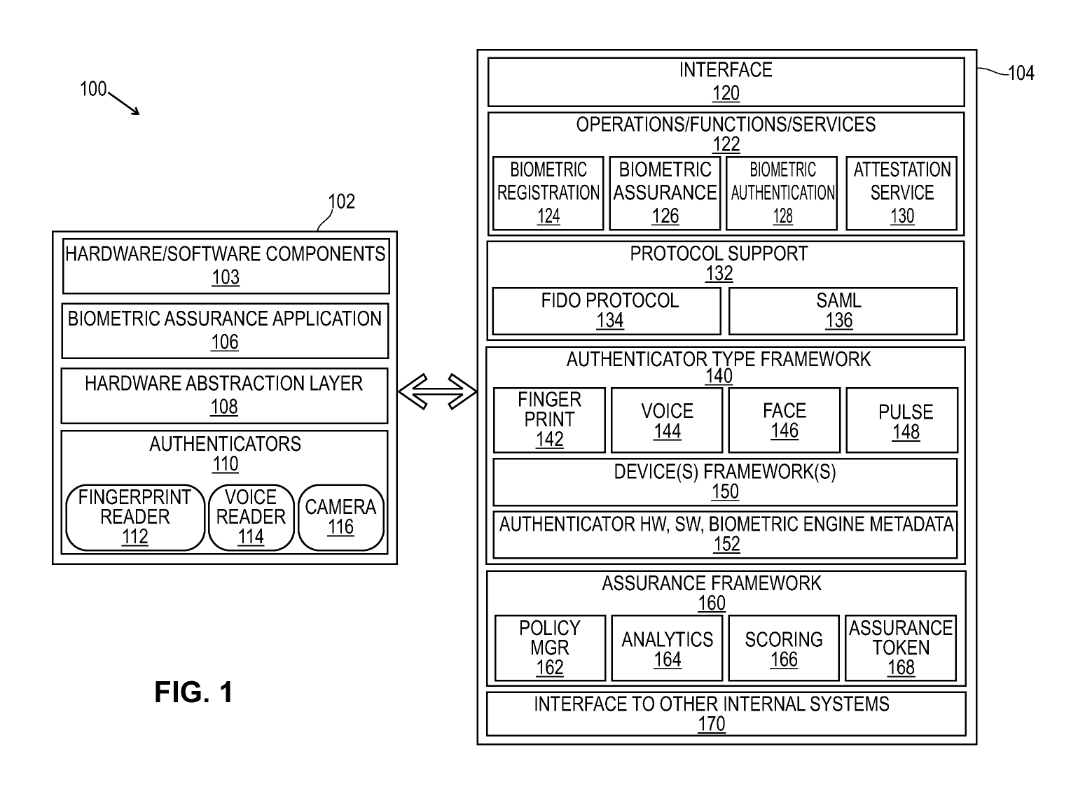

Features of some embodiments will now be described by reference to FIG. 1, which is a block diagram of components of a portion of a transaction system 100 pursuant to some embodiments. The components of the transaction system 100 shown in FIG. 1 are described in more detail in co-pending and commonly assigned U.S. patent application Ser. No. 14/684,749, the contents of which are hereby incorporated by reference in their entirety for all purposes. A system pursuant to some embodiments involves a number of devices and entities interacting to conduct a transaction. For example, users may operate mobile devices 102 to interact with an assurance platform 104 pursuant to the present invention. While only a single mobile device 102 and assurance platform 104 are shown in FIG. 1, in practice, a large number of such devices may be involved in a system in accordance with embodiments described herein.

As shown in FIG. 1, the mobile device 102 has a number of logical and/or functional components (in addition to the normal components in a mobile device), such as hardware and/or software components 103. For example, if the mobile device 102 is a smartphone, then it may include hardware components such as a touch screen display, a microphone, a speaker, controller circuitry, an antenna, a memory or storage device, a digital camera and one or more storage devices (not shown) in addition to software configured to provide smartphone functionality. Storage devices utilized in the devices and/or system components described herein may be composed of or be any type of non-transitory storage device that may store instructions and/or software for causing one or more processors of such electronic devices to function in accordance with the novel aspects disclosed herein.

The mobile device 102 may also include a biometric assurance application 106 (or other software or components to provide the functionality) as well as a hardware abstraction layer 108 that allows interaction with a number of hardware components or authenticators 110 for use in performing different types of authentication. Examples of authenticators 110 include, but are not limited to a fingerprint reader 112, a voice reader 114, and a camera 116 (which may be configured to perform facial recognition or the like). It should be understood that some mobile devices 102 may include two or more of such authenticators 110 in different combinations (for example, a particular brand and/or type of smartphone may include a voice reader 114 and a camera 116, but not a fingerprint reader 112, while other types of mobile devices and/or other smartphone types may include all three of these devices). Moreover, some types of mobile devices may only include one type of authenticator, for example a microphone configured for obtaining voice data of a user which can then be utilized to perform a voice recognition and/or voice authentication process.

Pursuant to some embodiments, some of the components of the mobile device 102 may be configured based on or using a standard such as the so-called “FIDO” standards promulgated by the Fast Identity Online Alliance (available at www.fidoalliance.org and incorporated herein by reference in their entirety for all purposes). Other standards or implementations may also be used with desirable results. Each mobile device 102 may be in communication with an assurance platform 104 via, for example, a FIDO application programming interface (API) or a third party assurance platform API.

As shown, the assurance platform 104 includes a number of components that allow the assurance platform 104 to interact with a mobile device 102 to perform an authentication process pursuant to novel aspects described herein, as well as to register information associated with users and/or mobile devices and/or other system participants (such as, for example, information from financial institutions or other entities that wish to utilize the features of the novel systems and/or processes for authentication processing). Thus, the assurance platform includes one or more authentication processors (not shown) operably connected to one or more storage devices (not shown), which storage devices contain instructions configured to cause the authentication processors to function in accordance with the processes described herein.

The assurance platform 104 may include components including an interface 120 (which may be implemented as a Web service using SOAP/REST or other techniques) which allows communication between mobile devices 102 and other entities. A number of operations, functions or services 122 may also be provided (and which may be accessible using the Web service interface) such as, for example, a biometric registration method 124, a biometric assurance method 126, a biometric authentication method 128, and an attestation service 130. The assurance platform 104 may also provide protocol support 132 services or components providing support for different authentication protocols or techniques such as, for example, the Fast Identity Online (FIDO) protocol 134 and/or the Security Assertions Markup Language (SAML) protocol 136, or the like). Different authenticator type frameworks 140 may also be provided to provide support for different authenticator types. For example, frameworks may be provided for fingerprint 142, voice 144, face 146, pulse 148 or other biometric authentication techniques. Device frameworks 150 may also be provided for different device types (for example, for different mobile telephone makes and models, and/or for tablet computers running different types of operating systems and having different capabilities, and/or the like) as well as for different hardware and software components. The Authenticator type framework 140 may also include authentication hardware, software and/or biometric engine metadata 152 (which is data that describes and/or gives information about other data; thus metadata can be used, for example, to facilitate locating and/or working with particular instances of data).

The assurance platform 104 may also provide data and components associated with different assurance frameworks 160 which may include a policy manager 162, analytics 164, scoring 166, and assurance token data storage 168. In addition, an interface 170 to other internal systems of the assurance platform 104 may be provided. As will be described further herein, these frameworks and components allow a wide variety of devices as well as a wide variety of authentication users to interact to provide a high level of authentication for a wide variety of different transactions.

Pursuant to some embodiments, a variety of mobile device applications and/or web interactions can be provided in conjunction with the enhanced authentication platform 104. For example, an identity check mobile authentication application may be provided which provides full featured biometric authentication solutions for a variety of different use cases. The identity check application may be distributed via a “white label” solution in some implementations, or may be distributed via a software development kit (“SDK”) that may be embedded in a mobile device application (such as a mobile banking application issued and maintained by a financial institution).

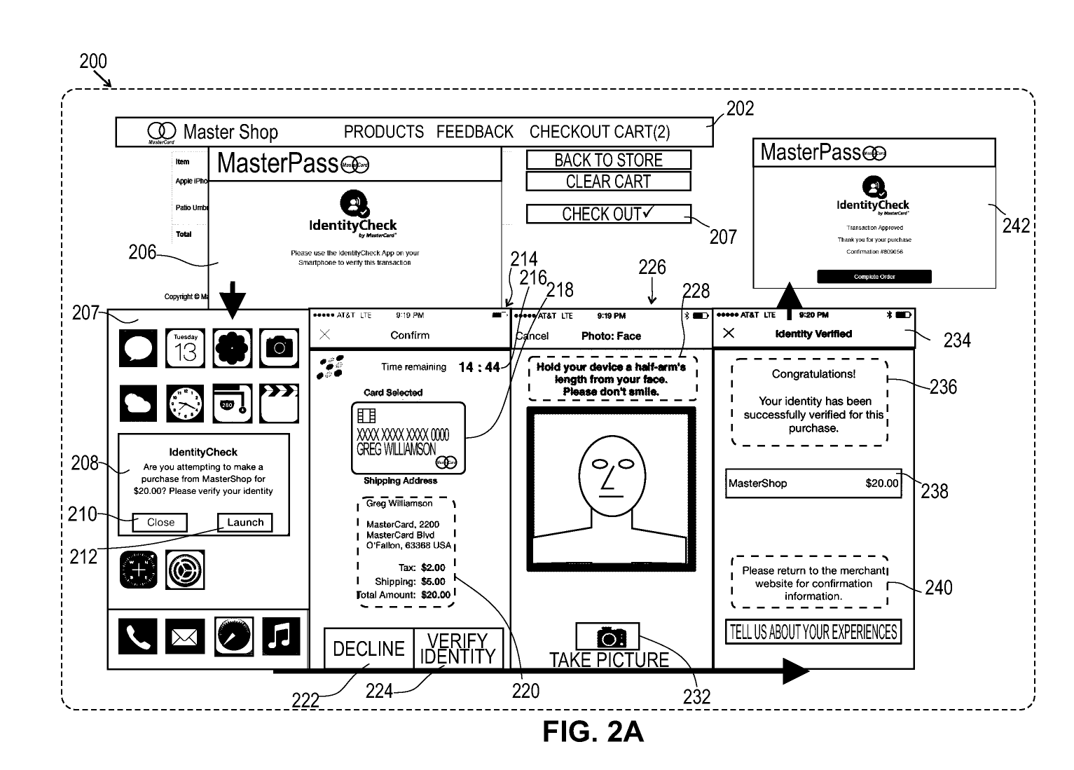

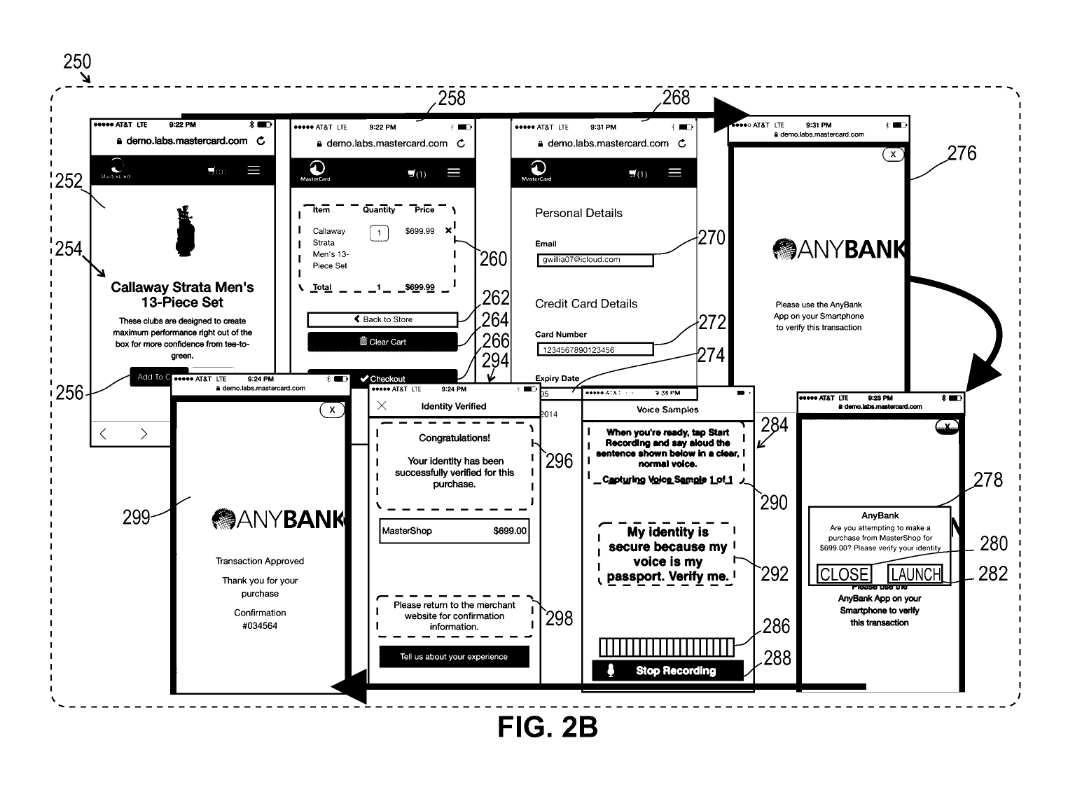

FIGS. 2A and 2B illustrate examples of user interface screens in accordance with mobile device user authentication processes which provide user experiences 200 and 250, respectively, of example identity check mobile authentication applications in accordance with some embodiments. Those skilled in the art will appreciate that the illustrative user interfaces shown in FIGS. 2A and 2B (and any other user interfaces illustrated herein) are for illustrative and non-limiting purposes, and that other user interfaces and/or user interactions may be used in conjunction with the systems disclosed herein.

Referring to FIG. 2A, an example user experience 200 is shown which includes a user or consumer first utilizing an electronic device, such as a laptop computer, to shop at a “MasterShop” website (operated by a merchant offering goods and/or services for sale), and then utilizing a separate mobile device to provide authentication information during a transaction in accordance with an enhanced authentication process. In particular, FIG. 2A depicts a plurality of user interface screens that appear in a serial or consecutive fashion on a display screen of the user's mobile device to illustrated the progress of an authentication process. Thus, in the example shown in FIG. 2A, a user may utilize his or her laptop computer to shop at the “MasterShop” website, and then selects one or more items that are placed into a virtual shopping cart. When finished shopping, the user selects or clicks-on a checkout icon or check-out button 204. This selection causes an “IdentityCheck” information box 206 to then appear on the display screen of his or her laptop directing the user (or consumer or cardholder) to: “Please use the IdentityCheck App on your Smartphone to verify the transaction.” Next, the user utilizes his or her Smartphone and selects the IdentityCheck application by tapping an IdentityCheck icon (not shown) on a touch screen 207, which causes a query box 208 to appear on the mobile device display screen. (It should be understood that the IdentityCheck application is an example of a mobile device authentication which may be provided by an authentication platform service provider or, for example, a financial institution which issues payment accounts).

In some embodiments, as shown in FIG. 2A, the query box 208 appearing on the user's mobile device display screen includes a question and statement for the user: “Are you attempting to make a purchase from MasterShop for $20.00? Please verify your identity.” Thus, in some implementations information and/or data regarding the consumer's shopping cart is pushed to the consumer's mobile device for authentication processing. As shown, the query box 208 also includes a “Close” button 210 (if the consumer does not wish to proceed with the purchase) and a “Launch” button 212. When the consumer selects the “Launch” button 212, then the IdentityCheck application initiates and causes a Confirmation interface screen 214 to appear, which in some embodiments includes a count-down timer 216 that indicates the time remaining for the user or consumer to verify his or her identity. In some embodiments, a representation of the consumer's payment card 218 may be displayed, which payment card account may have been pre-selected by the consumer. For example, the particular payment card 218 may have been chosen by the user for use in all online purchase transactions, or for use with all transactions with MasterShop. But in some other embodiments, the consumer may be prompted to select a payment account from a list (not shown) of financial accounts stored in a mobile wallet of the user's mobile device (which may include, for example, credit card accounts and/or debit card accounts and/or loyalty card accounts, and the like).

In some implementations, the Confirmation interface screen 214 may also include transaction detail information 220, which may include payment card account detail information (such as a primary account number (PAN) or credit card number, expiration date, and billing address), and/or an item listing and cost information (such as item description(s), purchase price(s), shipping costs and taxes, if any) for viewing by the consumer. A “Decline” button 222 and “Verify Identity” button 224 may also be provided for selection which should be used by the user before the count-down timer 216 expires. If the user selects the “Verify Identity” button 224 within the time allotted, then in some embodiments a “Photo” interface screen 226 appears. The Photo interface screen 226 includes instructions 228 such as: “Hold your device a half-arm's length from your face; Please don't smile,” and may include a window 230 showing a view of what the mobile device camera is seeing. In addition, a “Take Picture” icon 232 may be provided for use to take a “selfie” or self-portrait of the user's face for authentication purposes (in this case, a facial recognition process). After the user takes a digital photograph of his or her face, in some embodiments the digital photograph is transmitted to an authentication service platform computer (not shown) or to the assurance platform 104 (see FIG. 1) for authentication processing. For example, the authentication service platform computer 104 may operate to compare the digital photograph (captured by a camera of the user's mobile device) provided by the user to data representing facial identification data stored in a biometric database (not shown) in order to authenticate the user. If data in the biometric database matches the digital photograph of the user's face, then an “Identity Verified” interface screen 234 appears on the display 207 of the user's mobile device, which may include a message 236 stating: “Congratulations! Your identity has been successfully verified for this purchase.” Information of the transaction 238 may also be included, along with instructions 240 to: “Please return to the merchant website for confirmation information.” The user may then, for example, utilize his or her laptop to return to the MasterChop website, and then an information box 242 may be provided that includes information such as: “Transaction Approved” and a confirmation number.

FIG. 2B depicts mobile device screen shots for another example user experience 250 wherein a user or consumer uses his or her mobile device and a mobile web browser to shop on a merchant's website. In particular, FIG. 2B depicts a plurality of user interface screens that appear in a serial or consecutive fashion on the user's mobile device display screen 252 while shopping online at a merchant's website, in this example, for golf clubs. Thus, the display screen 252 depicts a picture 254 of a 13-piece golf club set and an “Add to Cart” button 256. If the consumer or user selects the “Add to Cart” button 256, then a shopping cart interface screen 258 is provided that includes information 260 listing the selected item(s), the quantity, and the price(s) of each item in the cart. Also provided are a back-to-store button 262, a clear cart button 264, and a checkout button 266. If the consumer selects the checkout button 266, then the “Personal Details” interface screen 268 appears, which includes user entry fields including an e-mail entry field 270, a credit card number field 272, and an expiry date field 274. After the user fills in the required information for all of the entry fields of the Personal Details interface screen 268, then an information box 276 appears on the display screen of the user's mobile device which directs the user (or consumer or cardholder) to “Please use the AnyBank App on your Smartphone to verify the transaction.” Next, the user locates and selects the Anybank application (for example, by tapping an AnyBank application icon (not shown)), which causes a query box 278 to appear on the mobile device display screen. The query box 278 includes a question and statement for the user: “Are you attempting to make a purchase from MasterShop for $699.00? Please verify your identity.” The query box 278 also includes a “Close” button 280 and a “Launch” button 282. When the consumer selects the “Launch” button 212, then in some implementations the AnyBank App initiates and causes a Voice Samples interface screen 284 to appear, which includes a Start Recording button 286, a Stop Recording button 288, and instructions 290 which state: “When you're ready, tap Start Recording and say aloud the sentences shown below in a clear, normal voice.” In the example shown, the sentences 292 the user must say aloud are: “My identity is secure because my voice is my passport. Verify me.” When the user is finished recording his or her voice saying the required sentences, he or she taps the Stop Recording button 288, which in some embodiments causes the user's mobile device to transmit the recorded sentences (i.e., to transmit the voice data) to a remote authentication service platform server computer for authentication processing.

In some embodiments, the authentication service platform server computer attempts to match the recorded voice data received from the user's mobile device with stored voice data, which may be stored in a biometric database. If a match occurs for that user, then an “Identity Verified” interface screen 294 appears on the display screen of the user's mobile device, which may include a message 296 stating: “Congratulations! Your identity has been successfully verified for this purchase.” As shown, information describing the transaction may be included, along with instructions 298 to: “Please return to the merchant website for confirmation information.” The user then utilizes his or her mobile web browser to return to the merchant's website, and an information box 299 may appear that includes information such as: “Transaction Approved” and a confirmation number.

It should be understood that, in some implementations, more than one form of user biometric data may be required from the user in order to authenticate the user for a particular transaction. For example, if a consumer is attempting to purchase an expensive item from an online merchant (for example, a wristwatch valued at more than one thousand dollars) then in addition to voice data, an entity (such as the merchant and/or an issuer financial institution) may also require photographic data representing the user's face, and/or a password or personal identification number (PIN) to be provided by the user.

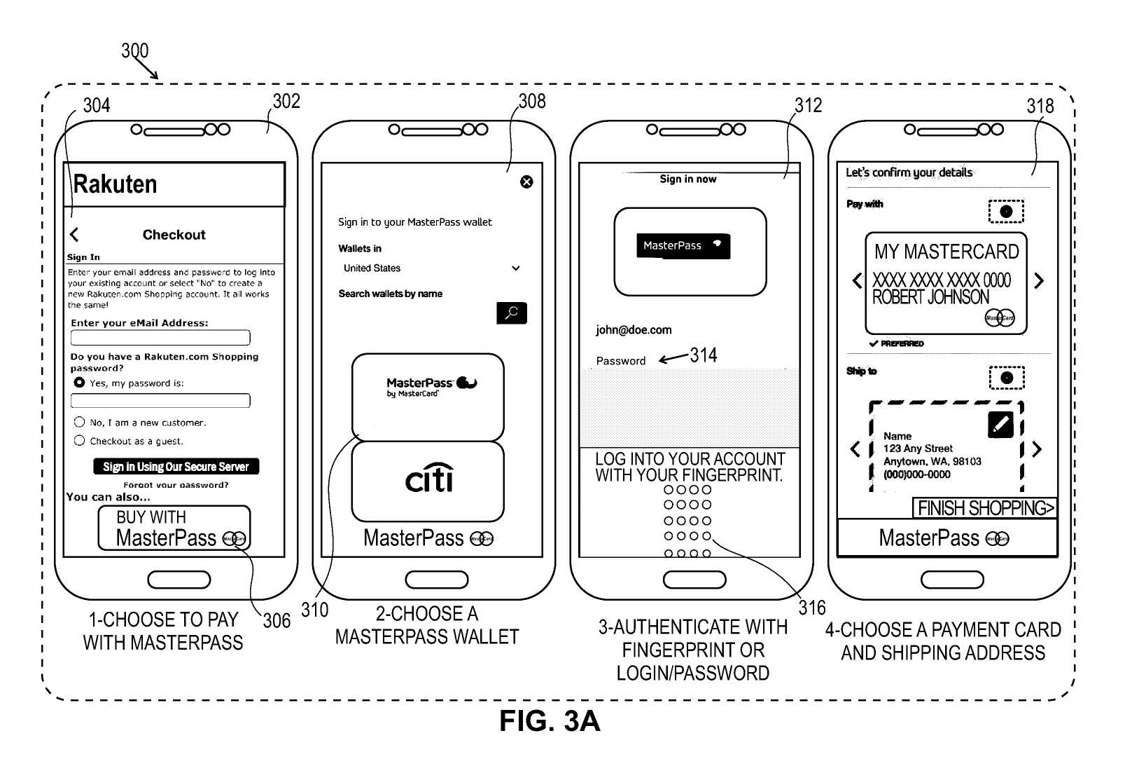

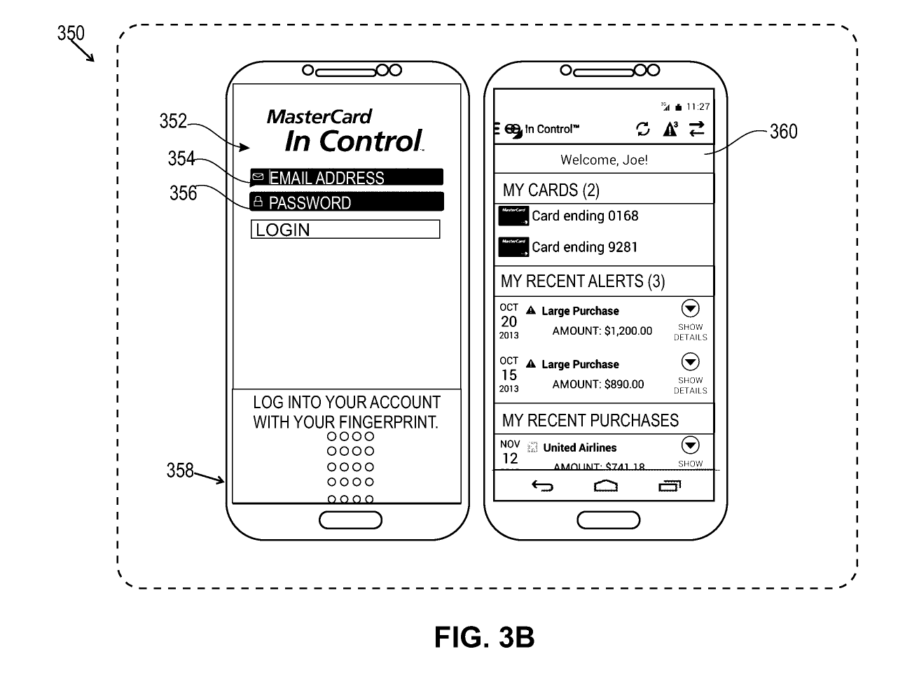

FIGS. 3A and 3B illustrate further examples of a mobile application and/or web interaction that is supported by the disclosed enhanced authentication platform, wherein several device authenticated access control applications are shown. In particular, FIG. 3A shows a smartphone 302 that includes the capability to obtain fingerprint data from a user. In the example shown, the mobile telephone or smartphone user has been shopping using his or her smartphone 302 and a mobile web browser on the “Rakuten” website, and the “checkout” webpage 304 is shown on the mobile device display screen. When the consumer or mobile device user taps on the “MasterPass” button 306, the MasterPass wallet sign-in interface screen 308 appears. By doing so, the mobile device user has avoided having to fill in or type his or her e-mail address and a password or provide other information to proceed. Instead, the MasterPass wallet sign-in interface screen 308 includes entry fields to select a particular MasterPass wallet or a particular payment card account, and in this example the user taps on the “MasterPass” account icon 310. In response, the MasterPass application causes a “sign-in now” interface screen 312 to appear that includes a password field 314 and a fingerprint landing area 316, either of which can be utilized by the user to login. Once the user provides his or her fingerprint (typically by tapping an index finger on the fingerprint landing field), then an confirmation interface screen 318 appears, which may permit the user to select a particular payment card account and/or shipping address and the like, and to finish by tapping on a Finish shopping icon.

FIG. 3B depicts an in-control process 350, wherein a smartphone 302 can be utilized by a user to launch a mobile application control application in accordance with some embodiments of the disclosure. Once the in-control application is launched, the user can log in by either providing information in an e-mail address field 354 and a password field 356, or by providing a fingerprint onto the fingerprint landing area 358 (typically by tapping an index finger on the fingerprint landing field). When the log-in is successful, a welcome interface screen 360 is provided, which provides information to the user concerning his or her payment card accounts and/or payment activity. The interface screen 360 may also permit the user to customize and/or modify one or more characteristics or criteria regarding his or her mobile wallet account(s) and/or payment card account(s).

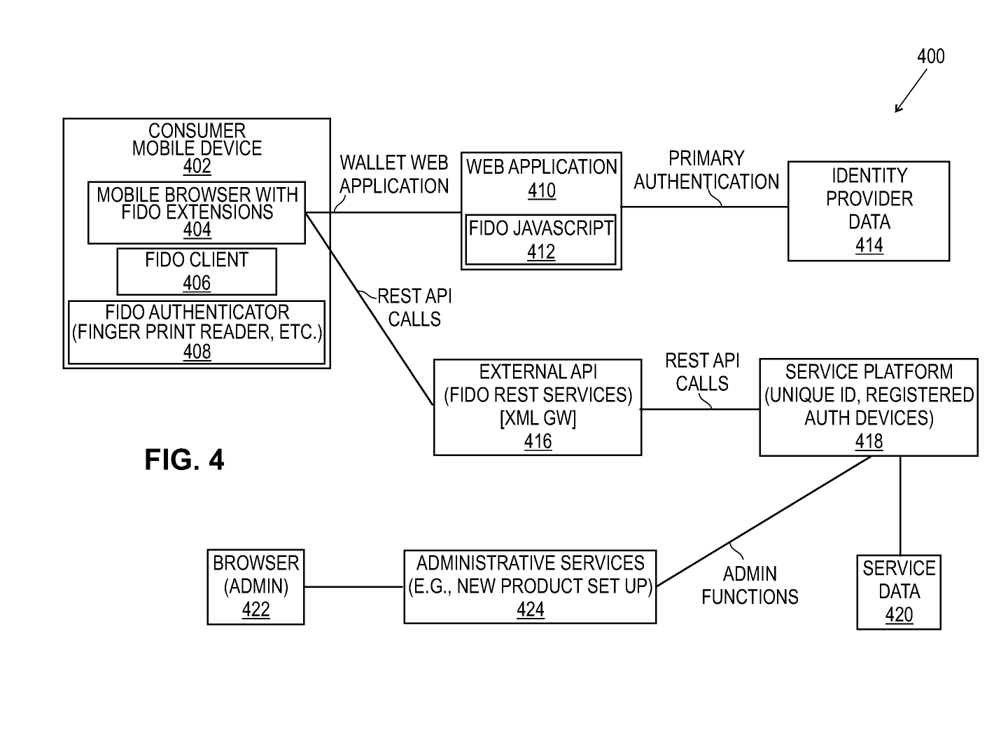

Pursuant to some embodiments, the enhanced authentication platform and processes disclosed herein may be used as a replacement or alternative for traditional user name and password access control platforms and/or processes. Such enhanced authentication processes deliver a frictionless authentication experience to users (such as cardholders and/or consumers), and minimize fraud risk. In some embodiments, such an enhanced authentication application may leverage cryptographic processing capabilities of mobile devices allowing the use of biometrics as access control. For example, the user interfaces of FIGS. 3A and 3B may be used to implement a process, such as the process described herein with regard to the system of FIG. 4, to allow fingerprint (or other biometric) features to be used as access control on a mobile device. In addition, in some embodiments the enhanced authentication platform may be able to query a user's mobile device to identify one or more available authenticators supported by the device (for example, to identify whether or not a particular mobile device includes a fingerprint reader, a digital camera, a microphone, and/or the like). Further, in some embodiments, the enhanced authentication platform may allow a third party (such as a financial institution or the like) to define one or more acceptable authenticator(s) and/or set or define one or more risk thresholds. In some implementations, such risk thresholds may be based on metadata available from an authenticator on the mobile device. Yet further, mobile device blacklist management may also be supported, for example, so that mobile devices that have been reported lost or stolen by users are denied access to the authentication processes described herein. The enhance authentication platform may also be configured to allow devices to be de-registered.

FIG. 4 is a block diagram of devices and/or components of a portion of a transaction system 400 illustrating a FIDO implementation that can be used to perform an user authentication process pursuant to some embodiments of the disclosure. A mobile device 402 operated by a user or consumer includes a mobile browser 404 with one or more FIDO extensions, a FIDO client 406 (which provides an abstraction layer to control certain device functions), and one or more FIDO authenticators 408 (for example, a fingerprint driver manufactured by the Synaptics™ Corporation). The mobile device 402 is configured to interact with a number of applications and/or application programming interfaces (APIs) to register a user and/or to perform a user authentication process. For example, as shown, the user or consumer may operate a supported mobile device 402 (for example, a Galaxy S6™ which is a Smartphone manufactured by the Samsung Corporation) to perform a registration process. The mobile device 402 may utilize a wallet web application to interact with a remote web application server 410 through use of the mobile browser 404 via the Internet (not shown) or other network, which web application server 410 includes a FIDO javascript 412. Such an interaction allows the user or consumer (such as a user of a mobile device having a mobile wallet) to register a fingerprint (for example, fingerprint data obtained from the FIDO authenticator 408 of the mobile device) with the wallet service provider. In some implementations, the user's fingerprint data (and in some implementations, additional biometric data) is stored in an identity provider database 414 in such manner that ties together or maps the biometric data to the mobile device user (and such functionality can be applied to a plurality of mobile device users). The mobile device 402 may also utilize REST API calls to communicate with external API FIDO REST services 416, which may also utilizes REST API calls to communicate with a service platform server computer 418 (which may be a FIDO server). The service platform server computer 418 may be configured to store unique identifiers and/or registered authentication device data in a service data database 420, and to utilize such identifiers and/or registered device data during user authentication processing. Also shown in FIG. 4 is an administrator computer 422 which may include browser software configured for communications via the internet with an administrative services computer 424 for use in setting up new user accounts, and the like. In some embodiments, the administrative services computer 424 is also configured for communications with the service platform server computer 418 in order to set-up and/or maintain user accounts and the like.

In some embodiments, when conducting a transaction requiring user authentication (such as providing user access to a building and/or user access to a public transportation system) the user operates the mobile device 402 to login to a wallet service (or other service or application) using an approved authenticator (such as a fingerprint) in place of a password. In some implementations, the web application server 410 functions to proxy the biometric data between the mobile device browser and the service platform 418.

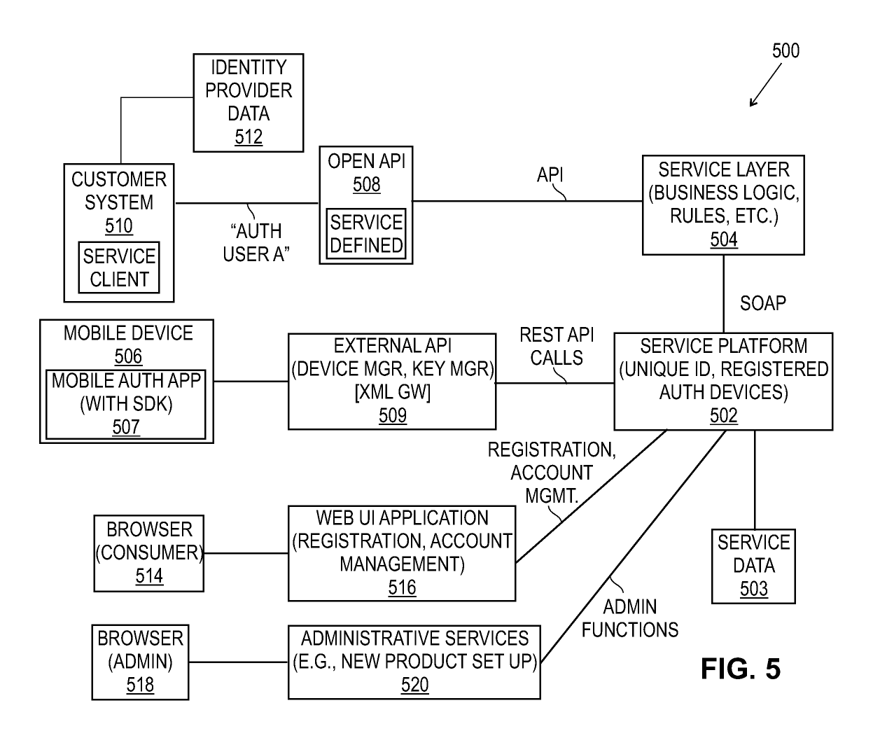

FIG. 5 is a block diagram of a portion of a transaction system 500 accessed by multiple data points and used to perform user authentication processes for certain transactions pursuant to some embodiments. The system 500 includes a service platform server computer 502, which may be operated by an entity (such as MasterCard International Incorporated, or the like) as a service provider, and a service layer 504 that includes business logic and/or authentication rules. The service platform 502 is exposed to service clients via an API 508, and is operably connected to a service data database 503 which may contain biometric data and the like user authentication data. The service platform is configured to apply the rules and business logic to authentication transactions via a protocol (such as a SOAP interface), which allows the service platform 502 to perform authentication transactions with user mobile devices 506 operating a mobile authentication application 507 via an External API 509 (which may include device manager and/or key manager protocols).

FIG. 5 also includes a customer system 510 operable to communicate with an identity provider database 512 and to communicate with the Open API 508 to authorize a user. In an illustrative embodiment, a consumer or user may interact via a device browser 514 with a web user interface application 516 to register his or her mobile device, to download the mobile authentication application to the registered mobile device, and/or to manage his or her mobile device account. In addition, an administrator 518 may interact via a web browser with an administrative services application 520 to set-up and/or maintain or administer a new user account with the service platform 502.

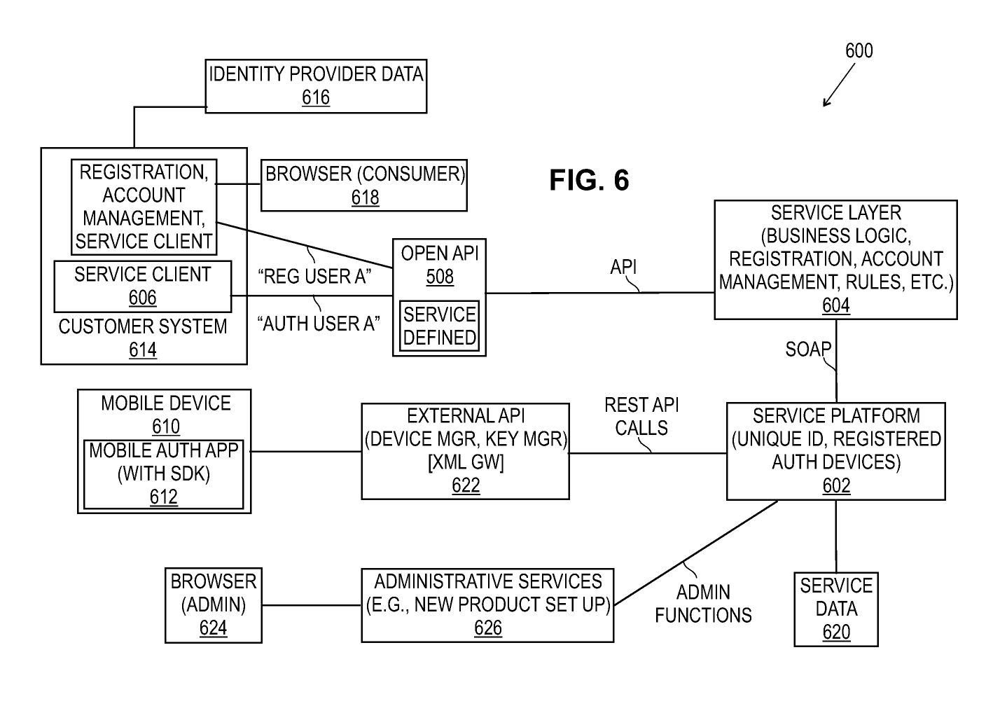

FIG. 6 is a block diagram of a portion of a transaction system 600 that may be used to perform user registration and authentication transaction processing pursuant to some embodiments of the disclosure. An entity (such as MasterCard International Incorporated or the like) again may operate a service provider platform 602 that functions with a service layer 604 having business logic and authentication rules. The service layer 604 is exposed to service clients 606 via an API 608, and the rules and business logic are applied to transactions requiring user authentication via a protocol (such as a SOAP interface) to allow the service platform 602 to authenticate a user of a mobile device 610 operating a mobile authentication application 612.

In the embodiment depicted in FIG. 6, the consumer system 614 provides an interface to support functions such as user registration and authentication (via the Open API 608). Thus, the consumer system 614 is operably connected to an identity provider database 616 and may be controlled by a consumer using a browser 618. In some implementations, the service platform 602 may be in communication with a service data database 620 (which contains biometric data of users), and may be operable to communicate with a user's mobile device 610 via an External API 622. In addition, an administrator device 624 may interact via a browser with an administrative services application 626 to set-up and or administer a new user account with the service platform 602.

It should be understood that, in some of the depicted embodiments, the authorization transaction may utilize the FIDO protocol; however, those skilled in the art will realize that other protocols may be used.

A user may follow a process flow such as illustrated with regard to FIGS. 4-6 to register one or more biometric data items (for example, a user may create fingerprint biometric data, voice data (i.e., a voice print), facial data, and/or other data, such as pulse data (i.e., heartbeat data), gait data (i.e., walking style data), and/or the like) and to utilize those biometric data items to perform user authentication processing for a wide variety of different types of transactions and/or applications.

It should be understood that users may register a number of devices pursuant to the processes presented herein. Further, once the user has registered a particular device and a biometric dataset, that registration data may be used to authenticate a user with regard to different transactions involving different transaction methods. In addition, in some embodiments the user can register multiple devices and each user device can be associated with the same biometric dataset such that any of those registered devices can be used in transactions requiring user authentication.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. An authentication process, comprising:
receiving, by an authentication platform, a request to authenticate a user in conjunction with an online transaction with an entity;
determining, by the authentication platform, an authentication rule based on a policy associated with the entity;
transmitting, by the authentication platform, an authentication request to a mobile device associated with the user based on the authentication rule;
receiving, by the authentication platform from the user mobile device, authentication response data;
authenticating, by the authentication platform, the user in conjunction with the transaction when the authentication response data matches stored user authentication data; and
transmitting, by the authentication platform to the user mobile device, an authentication message.

2. The authentication process of claim 1, wherein the request to authenticate the user is received from a web browser of the user's mobile device.

3. The authentication process of claim 1, wherein the entity is one of a merchant or an issuer financial institution.

4. The authentication process of claim 1, wherein the authentication rule specifies at least one type of biometric data required to authenticate a user for the transaction.

5. The authentication process of claim 1, wherein the authentication rule specifies at least one of a type of authenticator required to authenticate a user and a risk threshold.

6. The authentication process of claim 5, further comprising determining, by the authentication platform, the risk threshold based on metadata from an authenticator of the user mobile device.

7. The authentication process of claim 1, wherein the authentication request transmitted to the user's mobile device comprises at least one prompt instructing the user to provide at least one form of user biometric data by using at least one authenticator of the mobile device.

8. The authentication process of claim 7, wherein the user biometric data comprises at least one of photographic data, fingerprint data and voice data.

9. The authentication process of claim 1, wherein the authentication message transmitted to the user's mobile device comprises a verification message associated with the online transaction.

10. The authentication process of claim 1, further comprising, after determining the authentication rule:
transmitting, by the authentication platform, a request to the user mobile device to identify available authenticators supported by the user mobile device; and
receiving, by the authentication platform from the user mobile device, a response to the request identifying at least one authenticator.

11. An authentication system comprising:
at least one user mobile device comprising at least one authenticator; and
an authentication platform in communication with the at least one user mobile device, the authentication platform comprising at least one authentication processor operably connected to a storage device, wherein the storage device includes instructions configured to cause the authentication processor to:
receive a request to authenticate a user in conjunction with an online transaction with an entity;
determine an authentication rule based on a policy associated with the entity;
transmit an authentication request to a mobile device associated with the user based on the authentication rule;
receive authentication response data from the user mobile device;
authenticate the user in conjunction with the transaction when the authentication response data matches stored user authentication data; and
transmit an authentication message to the user mobile device.

12. The system of claim 11, further comprising a customer system in communication with the authentication platform, wherein the request to authenticate the user is received from the customer system.

13. The system of claim 11, further comprising an administrator computer in communication with the authentication platform, wherein the administrator computer functions to register users and handle administrative functions.

14. The system of claim 11, further comprising a biometric database operably connected to the authentication platform, the biometric database storing at least one type of biometric data associated with users for performing authentication processing.

15. The system of claim 11, wherein the at least one authenticator comprises at least one of a digital camera, a fingerprint reader, and a microphone for recording voice data.

16. The system of claim 11, wherein the instructions for determining the authentication rule further comprises instructions configured to cause the authentication processor to determine that the user mobile device includes at least one required authenticator is required.

17. The system of claim 11, wherein the instructions for determining the authentication rule further comprises instructions configured to cause the authentication processor to determine a risk threshold based on metadata from at least one authenticator of the user mobile device.

18. The system of claim 11, wherein the instructions for determining the authentication rule further comprises instructions configured to cause the authentication processor to:
transmit a request to the user mobile device to identify available authenticators supported by the user mobile device; and
receive a response to the request from the user mobile device identifying at least one authenticator.
